(19) United States
(12) Patent Application Publication
(10) Pub. No.: US 2007/0259219 A1
(43) Pub. Date: Nov. 8, 2007

(54) Technique and apparatus to detect and recover from an unhealthy condition of a fuel cell stack

(76) Inventors: Jing Ou, Latham, NY (US); Zhi Zhou, Selkirk, NY (US); Vishnu Poonamallee, Tamilnadu (IN); Lam F. Wong, Waterford, NY (US); Kenneth M. Rush, Clifton Park, NY (US); Dustan L. Skidmore, Latham, NY (US); John W. Parks, Loudonville, NY (US)

Correspondence Address: TROP PRUNER & HU, PC, 1616 S. VOSS ROAD, SUITE 750, HOUSTON, TX, 77057-2631, US

(21) Appl. No.: 11/645,244

(22) Filed: Dec. 22, 2006

Related U.S. Application Data
(63) Continuation-in-part of application No. 11/311,613, filed on Dec. 19, 2005.

(51) Int. Cl. H01M 8/00

(52) U.S. Cl. 429/12

(57) ABSTRACT

A technique that is usable with a fuel cell stack includes detecting an unhealthy condition of the stack, such as carbon monoxide poisoning, flooding, or fuel starvation, and implementing a recovery action to correct the detected condition. The technique further includes observing the response of the stack to the recovery action to distinguish between unhealthy conditions that have the same indications. In the event that multiple unhealthy conditions are present concurrently, the technique also includes determining an appropriate sequence of recovery actions to correct each of the unhealthy conditions.

### CROSS REFERENCE TO RELATED APPLICATIONS

This application is a continuation-in-part of patent application Ser. No. 11/311,613, entitled “TECHNIQUE AND APPARATUS TO DETECT CARBON MONOXIDE POISONING OF A FUEL CELL STACK” filed on Dec. 19, 2005, and is incorporated herein by reference in its entirety.

### BACKGROUND

The invention generally relates to a technique and apparatus to detect and recover from an unhealthy operating condition of a fuel cell stack.

A fuel cell is an electrochemical device that converts chemical energy directly into electrical energy. For example, one type of fuel cell includes a proton exchange membrane (PEM) that permits only protons to pass between an anode and a cathode of the fuel cell. Typically PEM fuel cells employ sulfonic-acid-based ionomers, such as Nafion, and operate in the 60° Celsius (C.) to 70° C. temperature range. Another type employs a phosphoric-acid-based polybenziamidazole, PBI, membrane that operates in the 150° C. to 200° C. temperature range. At the anode, diatomic hydrogen (a fuel) is reacted to produce hydrogen protons that pass through the PEM. The electrons produced by this reaction travel through circuitry that is external to the fuel cell to form an electrical current. At the cathode, oxygen is reduced and reacts with the hydrogen protons to form water. The anodic and cathodic reactions are described by the following equations:
H₂→2H⁺+2e⁻ at the anode of the cell, and Equation 1
O₂+4H⁺+4e⁻→2H₂O at the cathode of the cell. Equation 2

A typical fuel cell has a terminal voltage near one volt DC. For purposes of producing much larger voltages, several fuel cells may be assembled together to form an arrangement called a fuel cell stack, an arrangement in which the fuel cells are electrically coupled together in series to form a larger DC voltage (a voltage near 100 volts DC, for example) to provide more power.

The fuel cell stack may include flow plates (graphite composite or metal plates, as examples) that are stacked one on top of another, and each plate may be associated with more than one fuel cell of the stack. The plates may include various surface flow channels and orifices to, as examples, route the reactants and products through the fuel cell stack. Several PEMs (each one being associated with a particular fuel cell) may be dispersed throughout the stack between the anodes and cathodes of the different fuel cells. Electrically conductive gas diffusion layers (GDLs) may be located on each side of each PEM to form the anode and cathodes of each fuel cell. In this manner, reactant gases from each side of the PEM may leave the flow channels and diffuse through the GDLs to reach the PEM.

The fuel cell stack is one out of many components of a typical fuel cell system. For example, the fuel cell system may also include a cooling subsystem to regulate the temperature of the stack, a cell voltage monitoring subsystem, a control subsystem, a power conditioning subsystem to condition the power that is provided by the fuel cell stack for the system load, etc. The particular design of each of these subsystems is a function of the application that the fuel cell system serves.

During the course of its operation, the fuel cell stack may potentially experience one or more “unhealthy” conditions, such as flow channel flooding, membrane drying, fuel starvation, and carbon monoxide poisoning. Early detection of unhealthy conditions is important to trigger a recovery scheme to prevent the stack from further performance degradation to the point that the system has to be shut down. Differentiation between unhealthy conditions is important because the appropriate recovery scheme relies on accurate identification of the underlying cause of the unhealthy condition. However, difficulties may arise in identifying the unhealthy condition because more than one type of unhealthy condition may present similar symptoms. Difficulties also may arise in selecting an appropriate recovery scheme. For example, different types of unhealthy conditions may be present simultaneously. In such a case, a recovery scheme that may be appropriate for one unhealthy condition may exacerbate other unhealthy conditions.

Thus, there exists a continuing need for better ways to detect unhealthy conditions and implement appropriate recovery schemes in response to such detection.

### SUMMARY

In an embodiment of the invention, a technique that is usable with a fuel cell stack includes detecting a first unhealthy condition of the stack, performing a first recovery action to correct the first unhealthy condition, and observing a response of the stack to the first recovery action. The technique further includes determining, based on the detected response, whether the first recovery action corrected the first unhealthy condition.

In another embodiment of the invention, a fuel cell system includes a fuel cell stack and a circuit configured to detect a first unhealthy condition of the fuel cell stack, perform a first recovery action to correct the first unhealthy condition, and determine whether the first unhealthy condition has been corrected based on the response of the fuel cell stack to the first recovery action.

In yet another embodiment of the invention, an article comprises a computer readable storage medium that is accessible by a processor-based system. The article stores instructions that when executed by the processor-based system cause the processor-based system to detect an unhealthy condition of the fuel cell stack, perform a first recovery action to recover the fuel cell stack to a healthy condition, where the first recovery action is associated with correcting a first unhealthy condition. The instructions further cause the processor-based system to observe a response of the fuel cell stack to the first recovery action, and determine, based on the response, whether the fuel cell stack recovered. If not, then the instructions cause the processor-based system to perform a second recovery action to recover the fuel cell stack to the healthy condition, where the second recovery action is associated with correcting a second unhealthy condition that is different than the first unhealthy condition.

In a further embodiment of the invention, a technique that is useable with fuel cell system includes detecting the presence of one of a first unhealthy operating condition and a second unhealthy operating condition of the fuel cell stack and performing a first recovery action. The technique further includes detecting a response of the fuel cell stack to the first recovery action and determining, based on the response, whether the detected unhealthy operating condition is the first unhealthy operating condition or the second unhealthy operating condition.

Advantages and other features of the invention will become apparent from the following drawing, description and claims.

### BRIEF DESCRIPTION OF THE DRAWING

FIG. 1 is a schematic diagram of a fuel cell system according to an embodiment of the invention.

FIG. 2 is a flow diagram depicting a technique to detect carbon monoxide poisoning in a fuel cell stack of the fuel cell system of FIG. 1 according to an embodiment of the invention.

FIG. 3 is a flow diagram depicting a technique to detect and correct flooding and fuel starvation in a fuel cell stack of the fuel cell system of FIG. 1 according to an embodiment of the invention.

FIG. 4 is a flow diagram depicting a technique to detect and correct simultaneously occurring unhealthy conditions in a fuel cell stack of the fuel cell system of FIG. 1 according to an embodiment of the invention.

### DETAILED DESCRIPTION

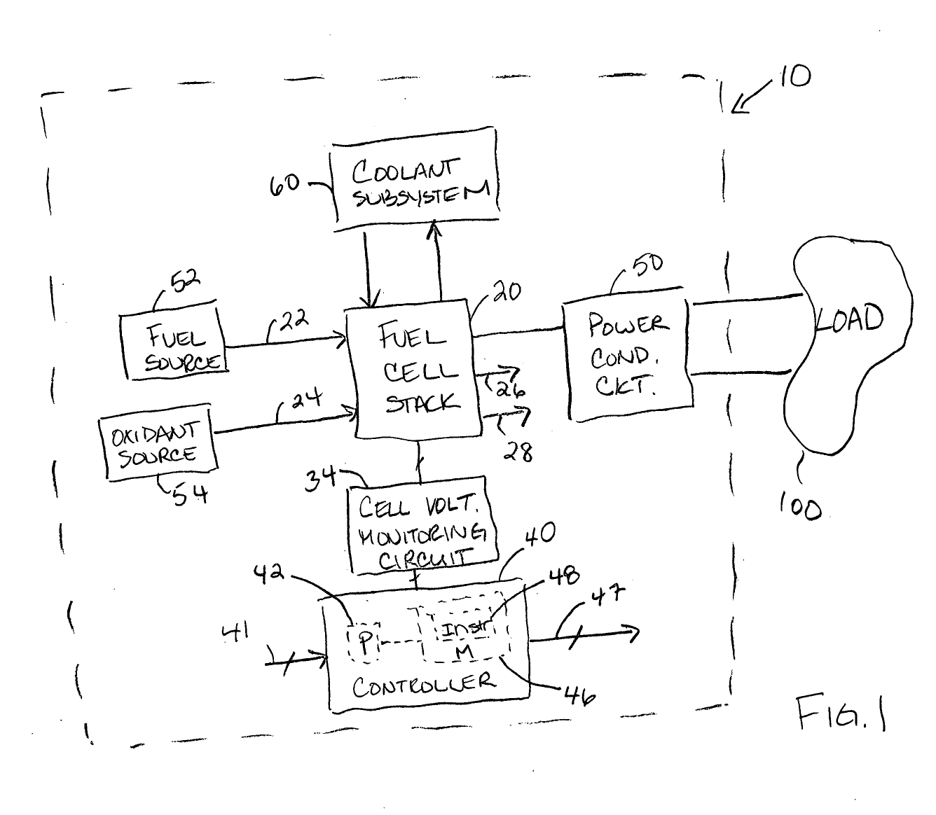

Referring to FIG. 1, in accordance with an embodiment of the invention, a fuel cell system 10 includes a fuel cell stack 20 (a PEM fuel cell stack, for example) that, in response to fuel and oxidant flows produces power for an electrical load 100. Power conditioning circuit 50 of the fuel cell stack converts a DC stack voltage of the fuel cell stack 20 into the appropriate voltage (DC or AC, depending on the type of load) for the load 100. For example, the load 100 may be a residential load and, may receive an AC voltage from the fuel cell system 10. However, in other embodiments of the invention, the fuel cell system 10 may provide a “DC” output voltage for the case where the load 100 is a DC load. Other variations are possible and are within the scope of the appended claims.

In accordance with embodiments of the invention, a fuel source 52 provides a fuel flow to the fuel cell stack 20 via an anode inlet 22. An oxidant source 54 provides an oxidant flow to a cathode inlet 24 of the fuel cell stack 20. The incoming oxidant flow to the fuel cell stack 20 passes through the oxidant flow channels of the fuel cell stack 20 to appear as cathode exhaust at a cathode outlet 28 of the stack 20; and the incoming fuel flow to the stack 20 passes through fuel flow channels of the fuel cell stack 20 and to appear as anode exhaust at an anode outlet 26 of the stack 20.

Depending on the particular embodiment of the invention, the anode exhaust of the fuel cell stack 20 may be partially or totally recirculated; the anode exhaust may be partially or totally furnished to a flare or oxidizer; or alternatively, the anode chamber of the fuel cell stack 20 may be “dead-headed.” Additionally, depending on the particular embodiment of the invention, the cathode exhaust of the fuel cell stack 20 may be recirculated, may be furnished to a flare or oxidizer, etc. Thus, many variations are possible and are within the scope of the appended claims.

It is possible that during the course of the operation of the fuel cell system 10, fuel cell stack 20 may experience one or more unhealthy operating conditions that cause deteriorated performance of stack 20 and which may eventually result in damage to stack 20. These unhealthy conditions include, but are not limited to, carbon monoxide poisoning, fuel starvation, and flooding. Carbon monoxide poisoning occurs when an unacceptably high level of carbon monoxide is present in stack 20. Fuel starvation occurs when an unacceptably low amount of fuel is provided to stack 20. Flooding is a condition in which unacceptably high levels of condensed water are present in either the oxidant flow channels or the fuel flow channels of stack 20. Each of these unhealthy conditions may cause the stack 20 to cease functioning and eventually may result in permanent damage to the stack 20 if corrective action is not taken. Thus, it is important to detect an unhealthy condition of the stack early on to prevent the stack 20 from further performance degradation or being damaged to the point that the fuel cell system 10 has to be shut down.

Therefore, in accordance with embodiments of the invention, the fuel cell system 10 performs a technique to detect an unhealthy condition so that timely measures may be taken to recover the stack 20 to a healthy operating condition and thereby reduce the risk of stack damage and possibly avoid unexpected shutdowns of system 10. These measures may, for example, involve controlling the fuel source 52, the oxidant source 54, the power conditioning circuit 50 or another component of the fuel cell system 10 until the unhealthy condition is corrected.

In accordance with embodiments of the invention described herein, the fuel cell system 10 monitors the stack's cell voltages to detect the unhealthy condition. The cell voltages are obtained via a cell voltage monitoring circuit 34, a circuit that regularly scans the cell voltages of the fuel cell stack 20 and communicates an indication of the scanned voltages to a controller 40 of the fuel cell system 10. An example of the cell voltage monitoring circuit 34 may be found in U.S. Pat. No. 6,140,820, entitled “Measuring Cell Voltages of a Fuel Cell Stack,” which issued on Oct. 31, 2000. Other embodiments of the cell voltage monitoring circuit 34 are possible and are within the scope of the appended claims.

As further described below, the controller 40 processes the cell voltages to derive a cell voltage profile and, from parameters obtained from the cell voltage profile, the controller 40 is able to detect the unhealthy condition.

The cell voltage profile may be viewed as being a collection of cell voltages of the fuel cell stack 20. The cell voltages of the cell voltage profile may be voltages of selected cells of the fuel cell stack 20, may be the cell voltages for all of the cells of the fuel cell stack 20, may be a reduced set of cell voltages based on a culling criteria, etc., depending on the particular embodiment of the invention.

Based on the cell voltage profile, the controller 40 determines whether an unhealthy condition has occurred in the fuel cell stack 20. If an unhealthy condition is detected, the controller 40 takes the appropriate action to prevent further damage to the fuel cell stack 20, such as alerting service personnel (via an alarm noise, electronic message, display panel icon, etc.), shutting down part or all of the fuel cell system 10 and/or controlling the fuel source 52, oxidant source 54, power conditioning circuit 50, or another component of the fuel cell system 10 to correct the unhealthy condition, depending on the particular embodiment of the invention.

As depicted in FIG. 1, in accordance with some embodiments of the invention, the controller 40 includes a processor 42 (one or more microprocessors and/or microcontrollers, as example) that is coupled to a memory 46 that may, for example, store program instructions 48 to cause the controller 40 to operate as described herein to regularly develop and analyze a cell voltage profile for purposes of detecting unhealthy conditions. As also depicted in FIG. 1, the controller 40 may include various input terminals 41 for purposes of receiving status signals, signals indicative of commands, etc. and the controller 40 may include output terminals 47 for purposes of controlling various aspects of the fuel cell system 10, such as controlling motors, valves, communicating messages, generating alarm conditions, etc., depending on the particular embodiment of the invention.

Turning now to more specific details of an exemplary embodiment for detecting the unhealthy condition, in accordance with some embodiments of the invention, the controller 40 relies on the following observed symptoms. With respect to the detection of carbon monoxide poisoning, when a PEM fuel cell stack experiences this unhealthy condition, the voltages of the fuel cell stack 20 drop (the first prong of the carbon monoxide poisoning test); and at the same time, the cell voltage profile of the fuel cell stack shows an up and down pattern: at one moment, some cell voltages go up and other cell voltages go down; and at the next moment, the cell voltages that went down go up and the cell voltages that went up go down. This phenomenon may be labeled “cell voltage dancing.”

Therefore, in accordance with some embodiments of the invention, the controller 40 monitors (via the cell voltage monitoring circuit 34) the fuel cell stack 20 to detect when the average cell voltage decays enough to indicate potential carbon monoxide poisoning. In accordance with some embodiments of the invention, the average cell voltage may be the average of all of the cell voltages of the fuel cell stack 20, may be the average voltage of a selected group of cell voltages of the fuel cell stack 20, may be the average voltage of a group of cell voltages derived pursuant to a culling procedure (further described below) used by the controller 40, etc. If, for example, in accordance with some embodiments of the invention, the cell voltage monitoring circuit 34 determines that the average cell voltage drops by approximately 0.05 volts (as an example), then the first prong of the carbon monoxide poisoning detection test has been satisfied.

For purposes of detecting cell voltage dancing (the second prong of the carbon monoxide poisoning test), in accordance with some embodiments of the invention, the controller 40 determines the standard deviation of the cell voltage profile. Thus, if the standard deviation exceeds a predetermined threshold (a standard deviation of 0.03, for example), then the second prong of the carbon monoxide poisoning test has been satisfied. At this point, the controller 40 concludes that carbon monoxide poisoning is occurring and takes the appropriate recovery action. One possible recovery action is to freeze or decrease the withdrawal of current from the fuel cell stack 20 until the controller 40 determines, based on parameters available from the cell voltage profile, that the carbon monoxide poisoning condition no longer is present. In some embodiments, controller 40 may implement this recovery action by, for example, communicating appropriate control signals to power conditioning circuit 50 via output terminals 47.

For purposes of distinguishing carbon monoxide poisoning from other unhealthy conditions, such as flow channel flooding, membrane drying and fuel starvation (as examples), the controller 40 excludes cell voltages at the upper and lower ends of the range of cell voltages that is spanned by the cell voltage profile. More specifically, in accordance with some embodiments of the invention, the controller 40 excludes the lowest ten percent and highest ten percent of the cell voltages from the cell voltage profile. Thus, by excluding the cell voltages at the extremes, the controller 40 is able to evaluate the general trend of the cell voltage profile.

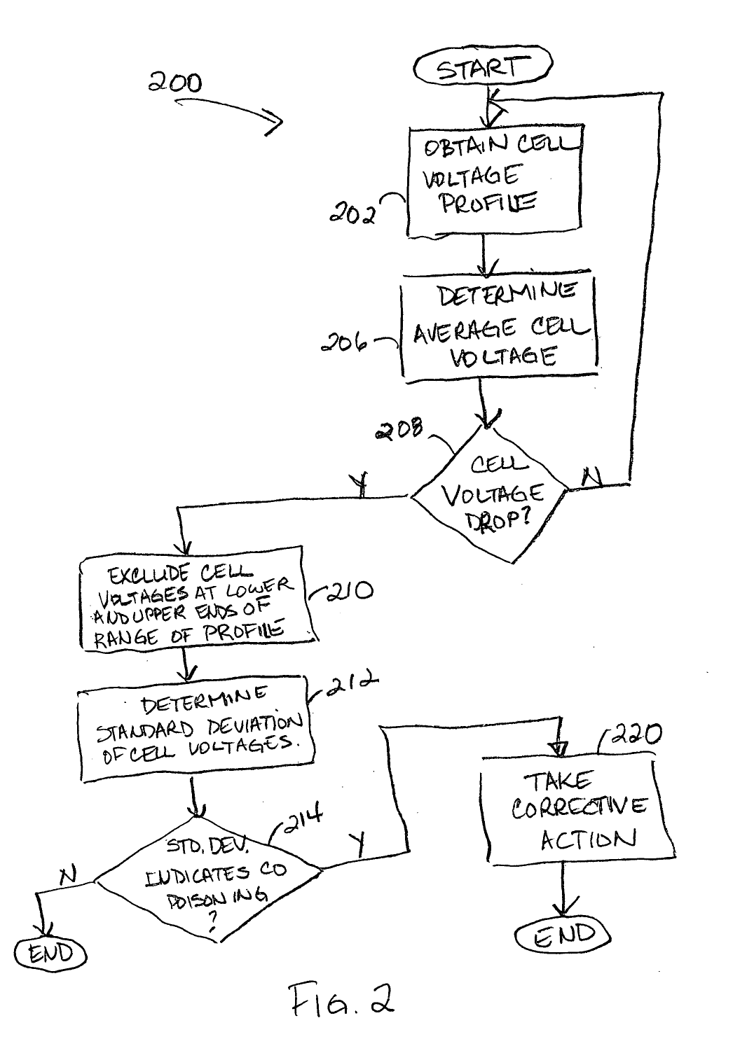

Referring to FIG. 2 in conjunction with FIG. 1, to summarize, in accordance with some embodiments of the invention, the controller 40 performs a technique 200 to detect carbon monoxide poisoning of the fuel cell stack 20. Pursuant to the technique 200, the controller 40 obtains (block 202) a cell profile including the measured cell voltages, such as by obtaining scanned cell voltages that are provided by the cell voltage monitoring circuit 34, for example. The controller 40 then determines (block 206) the average cell voltage.

If the controller 40 determines (diamond 208) that a cell voltage drop has occurred, then the first prong of the carbon monoxide poisoning test has been satisfied. Otherwise, control returns to block 202 to continue monitoring the average cell voltage.

If a cell voltage drop has been detected, then, pursuant to the technique 200, the controller 40 excludes (block 210) the cell voltages at the lower and upper ends of the range that is spanned by the cell voltage profile. Using the resulting set of cell voltages, the controller 40 determines (block 212) the standard deviation of the cell voltages of this set. Subsequently, pursuant to the technique 200, the controller 40 determines (diamond 214) whether the standard deviation indicates that carbon monoxide poisoning has occurred. If so, then the controller 40 takes the appropriate corrective action, as depicted in block 220.

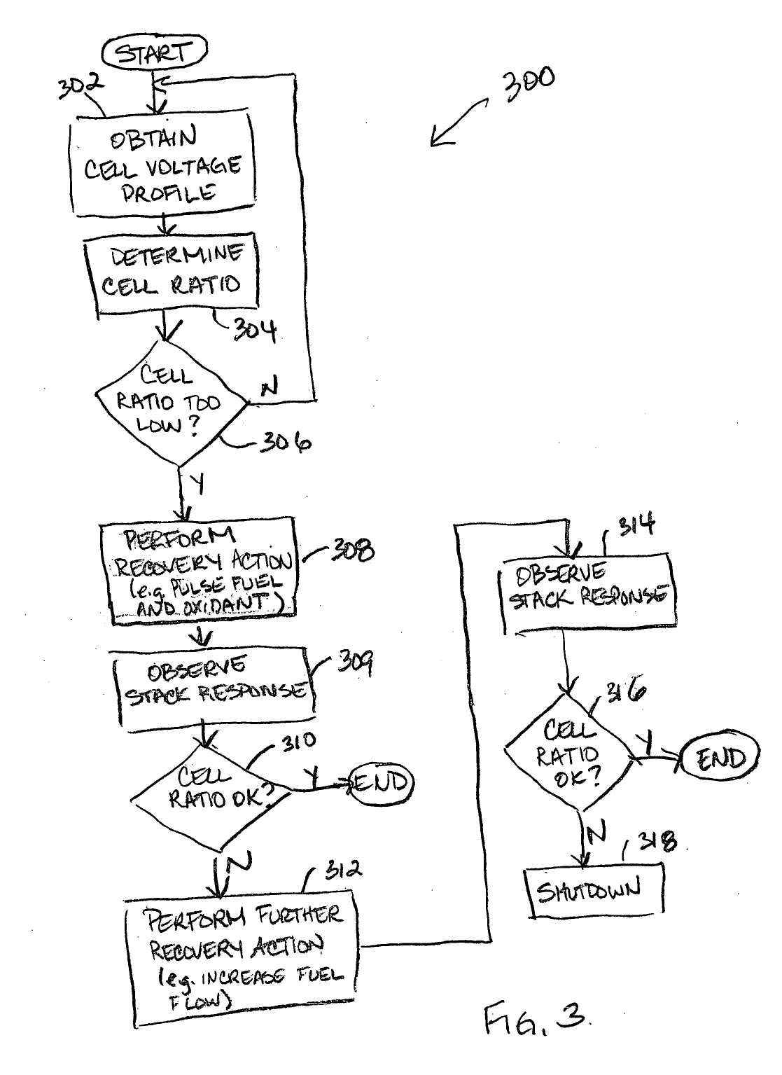

Other parameters derived from the cell voltage profile may be used to identify the occurrence of some of the other unhealthy conditions. For instance, referring to FIG. 3, the controller 40 may perform a technique 300 to detect flooding or fuel starvation of stack 200. Pursuant to technique 300, controller 40 obtains a cell profile including the measured cell voltage (block 302) and then determines a cell ratio. The cell ratio is the ratio between the lowest cell voltage in the range spanned by the cell voltage profile and the average cell voltage of the fuel cell stack 20. When the cell ratio reaches a predetermined low limit threshold (for example, 0.6), the cell ratio is indicative of either fuel starvation or flooding. Thus, when the controller 40 determines that the cell ratio has reached the low limit threshold (diamond 306), the controller 40 initiates a recovery action that may assist in correction of either or both the flooding and fuel starvation conditions (block 308). Otherwise, the controller 40 returns to block 302 to continue monitoring the cell voltages.

Because some types of unhealthy conditions, such as flooding and fuel starvation, present the same symptoms (e.g., low cell voltage ratio), controller 40 may not select the recovery action that is best suited to correct the particular unhealthy condition that is actually present in the stack 20. Thus, in some embodiments and as shown in FIG. 3, controller 40 may implement a first recovery action (block 308) and then observe the response of the stack 20 to the recovery action (block 309) to determine whether the detected unhealthy condition has been corrected (diamond 310). If not, then controller 40 may conclude that a different type of unhealthy condition is present and thus that a different type of recovery action may be needed to correct that condition (block 312).

Turning to a more specific example of distinguishing between different types of unhealthy conditions based on the fuel stack's response to a recovery action, in accordance with an embodiment of the invention and the technique 300 shown in FIG. 3, flooding and fuel starvation both are detected by observing a low cell voltage ratio. In one possible embodiment, when a low cell voltage ratio is detected, controller 40 may select a recovery action that includes pulsing both the oxidant flow provided by blower 34 and the fuel flow provided by fuel source 30 in a predetermined interval (for example, an interval of 5 seconds) (block 308). Pulsing the oxidant and fuel flows may correct the flooding condition as it may blow the condensed water out of the flow passages of the fuel cell stack 20. Pulsing the fuel flow may also correct the fuel starvation condition as it results in at least a temporary increase of fuel to the stack. Controller 40 may pulse the oxidant and fuel flows for a predetermined period of time, for a predetermined number of pulses, or until controller 40 observes that the cell voltage ratio has recovered to a nominal value or within a nominal range (for example, 0.8) (block 309). If the cell voltage ratio recovers in response to the pulsing action (diamond 310), then controller 40 may conclude that the unhealthy condition was flooding and return to block 302 to continue monitoring the cell voltages.

If controller 40 observes (block 309) that the stack's response to the pulsing action does not indicate that the unhealthy condition was corrected (e.g., the cell voltage ratio does not recover after either the predetermined time period or the predetermined number of pulses) (diamond 310), controller 40 may conclude that the unhealthy condition is fuel starvation and implement a further recovery action (block 312). For instance, controller 40 may initiate an incremental increase in the fuel flow provided by fuel source 30 or may freeze or incrementally decrease the amount of current drawn from the fuel cell stack 20 by load 100 to correct the fuel starvation condition. At this point in technique 300, controller 40 may continue to observe (block 314) the response of stack 20 to the recovery action and either implement further recovery actions (e.g., the same or different recovery actions) to correct the condition or return to monitoring the cell voltages if the condition has been corrected (diamond 316). In some embodiments, if controller 40 determines that the implemented recovery actions have not corrected the condition (diamond 316), then controller 40 may shutdown system 10 (block 318).

Stack 20 also may experience multiple unhealthy conditions that are present concurrently. As an example of this situation, controller 40 may observe, based on the cell voltage profile, two different symptoms which indicate two type of unhealthy conditions. Should this situation occur, controller 40 may need to coordinate or determine an appropriate sequence of recovery actions to avoid exacerbating one of the unhealthy conditions while attempting to correct the other unhealthy condition.

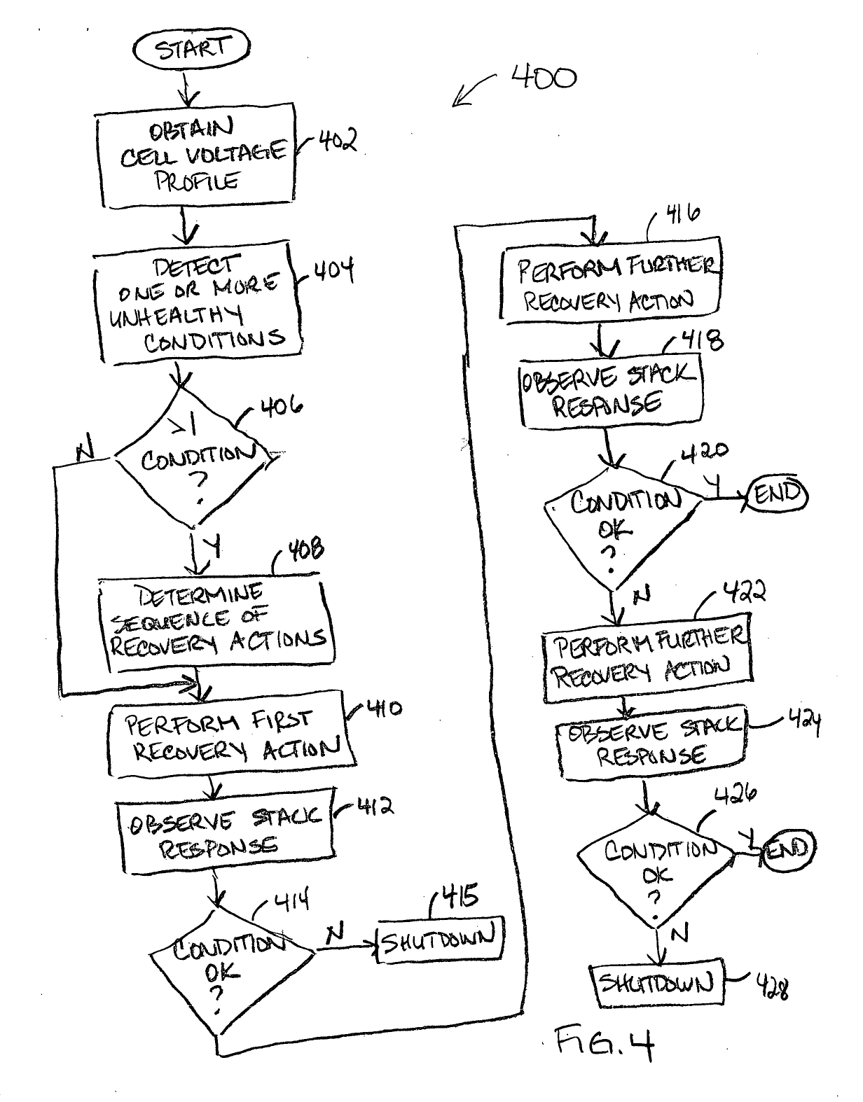

An example of a technique 400 to coordinate recovery actions is shown in FIG. 4. Pursuant to technique 400, controller 40 obtains the cell voltage profile (block 402) and detects, based on the profile, one or more unhealthy conditions (block 404). For instance, a combination of the average cell voltage and the standard deviation of the cell voltages may indicate the presence of carbon monoxide poisoning, while, at the same time, the cell voltage ratio may indicate the presence of either flooding or fuel starvation. However, the pulsing action for correcting flooding and fuel starvation will exacerbate the carbon monoxide poisoning due to the introduction of additional fuel into the stack 20. Thus, in instances where the controller 40 detects multiple unhealthy conditions that are present concurrently (diamond 406), controller 40 determines the sequence in which to perform the recovery actions before initiating any action (block 408). In this example, controller 40 first corrects the carbon monoxide poisoning by implementing the appropriate recovery action (e.g., freezing or incrementally decreasing the draw of current from the stack 20) (block 410), observes the response of stack 20 to determine whether the carbon monoxide poisoning is corrected (block 412), and, when corrected (block 414), implements another recovery action (e.g., pulsing of oxidant flow and fuel flow) to correct the flooding or fuel starvation condition (block 416). In some embodiments, if the recovery action does not correct the condition (diamond 414), then controller 40 may shutdown system 10 (block 415). Alternatively, controller 40 may implement other recovery actions in an attempt to correct the unhealthy condition prior to shutting down the system 10.

If controller 40 observes (block 418) that the stack's response to the second recovery action does not indicate that the unhealthy condition was corrected (e.g., the cell voltage ratio does not recover after either the predetermined time period or the predetermined number of pulses) (diamond 420), controller 40 may conclude that the unhealthy condition is fuel starvation and implement a different recovery action (block 422). For instance, controller 40 may initiate an incremental increase in the fuel flow provided by fuel source 30 or may freeze or incrementally decrease the amount of current drawn from the fuel cell stack 20 by load 100 to correct the fuel starvation condition. At this point in technique 400, controller 40 may continue to observe the response of stack 20 to the recovery action (block 424) and either implement further recovery actions to correct the condition or return to block 402 to continue monitoring the cell voltages if the condition has been corrected (diamond 426). In some embodiments, if controller 40 determines that the implemented recovery actions have not corrected the condition (diamond 426), controller 40 may shutdown system 10 (block 428).

While the invention has been disclosed with respect to a limited number of embodiments, those skilled in the art, having the benefit of this disclosure, will appreciate numerous modifications and variations therefrom. It is intended that the appended claims cover all such modifications and variations as fall within the true spirit and scope of the invention.

What is claimed is:

1. A method usable with a fuel cell stack, comprising:
detecting a first unhealthy condition of the fuel cell stack;
performing a first recovery action to correct the first unhealthy condition;
observing a response of the fuel cell stack to the first recovery action;
determining, based on the observed response, whether the first recovery action corrected the first unhealthy condition; and
performing a further recovery action if the first recovery action did not correct the first unhealthy condition.

2. The method as recited in claim 1, wherein the further recovery action is different than the first recovery action.

3. The method as recited in claim 1, further comprising.
detecting a second unhealthy condition of the fuel cell stack, the second unhealthy condition being present concurrently with the first unhealthy condition,
determining a sequence for performing a plurality of recovery actions to correct the first and second unhealthy conditions; and
performing the plurality of recovery actions in the determined sequence.

4. The method as recited in claim 3, wherein the second unhealthy condition is carbon monoxide poisoning and the recovery action to correct the second unhealthy condition is performed before the first recovery action to correct the first unhealthy condition.

5. The method as recited in claim 1, wherein the act of detecting the first unhealthy condition comprises.
determining a cell voltage profile of cell voltages of the fuel cell stack; and
detecting the first unhealthy condition based on the cell voltage profile.

6. The method as recited in claim 5, further comprising:
determining an average cell voltage based on the cell voltage profile, wherein the cell voltages in the cell voltage profile span a range; and
determining a cell ratio based on the average cell voltage and the lowest cell voltage in the range,
wherein the first unhealthy condition is detected based on the cell ratio.

7. The method as recited in claim 2, wherein the first unhealthy condition is one of fuel starvation and flooding, and wherein the first recovery action comprises pulsing fuel flow and oxidant flow to the fuel cell stack, and wherein the further recovery action comprises incrementally increasing fuel flow to the fuel cell stack.

8. A fuel cell system comprising:
a fuel cell stack;
a circuit configured to:
detect a first unhealthy condition of the fuel cell stack;
perform a first recovery action to correct the first unhealthy condition;
determine whether the first unhealthy condition has been corrected based on a response of the fuel cell stack to the first recovery action; and
perform a further recovery action to correct the first unhealthy condition if the first recovery action did not correct the first unhealthy condition.

9. The fuel cell system as recited in claim 8, wherein the further recovery action is different than the first recovery action.

10. The fuel cell system as recited in claim 9, wherein the circuit comprises:
a cell voltage monitoring circuit to monitor cell voltages of the fuel cell stack; and
a controller to receive an indication of the cell voltages from the cell voltage monitoring circuit, detect the first unhealthy condition based on the indication of the cell voltages, perform the first recovery action, determine whether the first unhealthy condition has been corrected, and perform the further recovery action.

11. The fuel cell system as recited in claim 10, wherein the controller determines whether the first unhealthy condition has been corrected based on the indication of cell voltages received from the cell voltage monitoring in response to the first recovery action.

12. The fuel cell system as recited in claim 8, wherein the circuit is configured to
detect a second unhealthy condition of the fuel cell stack that is present concurrently with the first unhealthy condition;
determine a sequence of a plurality of recovery actions to correct the first and second unhealthy conditions; and
perform the plurality of recovery actions in the determined sequence.

13. The fuel cell system as recited in claim 12, wherein the second unhealthy condition is carbon monoxide poisoning, and the circuit is configured to control performance of the recovery action to correct the carbon monoxide poisoning before the circuit controls performance of the first recovery action.

14. The fuel cell system of claim 8, wherein the circuit is configured to
determine a cell voltage profile of cell voltages of the fuel stack; and
detect the first unhealthy condition based on the cell voltage profile.

15. The fuel cell system of claim 14, wherein the circuit is configured to
determine an average cell voltage based on the cell voltage profile, wherein the cell voltages in the cell voltage profile span a range;
determine a cell ratio based on the average cell voltage and the lowest cell voltage in the range; and
detect the first unhealthy condition based on the cell ratio.

16. An article comprising a computer readable storage medium accessible by a processor-based system to store instructions that when executed by the processor-based system cause the processor-based system to:
detect an unhealthy condition of the fuel cell stack;
perform a first recovery action to recover the fuel cell stack to a healthy condition, the first recovery action being associated with correcting a first unhealthy condition;
observe a response of the fuel cell stack to the first recovery action;
determine, based on the observed response, whether the fuel cell stack recovered to the healthy condition; and
if not, perform a second recovery action to recover the fuel cell stack to the healthy condition, wherein the second recovery action is associated with correcting a second unhealthy condition that is different than the first unhealthy condition

17. The article as recited in claim 16, the storage medium storing instructions that when executed cause the processor-based system to:
detect another unhealthy condition of the fuel cell stack, the another unhealthy condition being present concurrently with the unhealthy condition,
determine a sequence for performing at least the first recovery action and another recovery action; and
perform the first and the another recovery actions in the determined sequence.

18. The article as recited in claim 16, the storage medium storing instructions that when executed cause the processor-based system to:
determine a cell voltage profile of cell voltages of the fuel stack; and
detect the unhealthy condition based on the cell voltage profile.

19. The article as recited in claim 18, the storage medium storing instructions that when executed cause the processor-based system to:
determine an average cell voltage based on the cell voltage profile, wherein the cell voltages in the cell voltage profile span a range;
determine a cell ratio based on the average cell voltage and the lowest cell voltage in the range; and
detect the unhealthy condition based on the cell ratio.

20. A method usable with a fuel cell stack, comprising:
detecting presence of one of a first unhealthy condition and a second unhealthy condition of the fuel cell stack;
performing a first recovery action;
observing a response of the fuel cell stack to the first recovery action;
determining, based on the observed response, whether the detected unhealthy condition is the first unhealthy condition or the second unhealthy condition.

21. The method as recited in claim 20, further comprising performing a second recovery action based on whether the detected unhealthy condition is the first second unhealthy condition or the second unhealthy condition.

22. The method as recited in claim 20, further comprising.
detecting presence of the second unhealthy condition, the second unhealthy condition being present concurrently with the first unhealthy condition,
determining a sequence for performing a plurality of recovery actions to correct the first and second unhealthy conditions; and
performing the plurality of recovery actions in the determined sequence.
